(19) United States
(12) Patent Application Publication
(10) Pub. No.: US 2018/0094105 A1
(43) Pub. Date: Apr. 5, 2018

(54) AQUEOUS DISPERSION OF PARTICLES OF AT LEAST ONE THERMOPLASTIC POLYMER, METHOD FOR PREPARING AND APPLICATIONS THEREOF, ESPECIALLY FOR SIZING REINFORCING FIBRES

(71) Applicants: ArianeGroup SAS, 7-11 quai André Citroën (FR); Centre National de la Recherche Scientifique, Paris Cendex 16 (FR)

(72) Inventors: Brigitte Defoort, Saint Medard en Jalles (FR); Aurélie Malho Rodrigues, Toulouse (FR); Sophie Franceschi, Pechbusque (FR); Emile Perez, Colomiers (FR)

(21) Appl. No.: 15/564,044

(22) PCT Filed: Apr. 1, 2016
(86) PCT No.: PCT/EP2016/057260

§ 371 Date: Oct. 3, 2017

(30) Foreign Application Priority Data
Apr. 3, 2015 (FR) 1552921

(51) Int. Cl. C08J 3/07; C08J 5/10; C08K 5/19; B01J 13/02; C08L 79/08; C08L 81/06

(52) U.S. Cl. CPC C08J 3/07; C08J 5/10; C08K 5/19; B01J 13/02; C08J 2381/06; C08L 81/06; C08J 2300/22; C08J 2379/08; C08L 79/08

(57) ABSTRACT

The invention relates to the use of giant micelles as shear-thinning agent in an aqueous dispersion of particles of at least one thermoplastic polymer. It also relates to an aqueous dispersion of particles of at least one thermoplastic polymer, comprising giant micelles located around the particles of the thermoplastic polymer(s), and also to a method that makes it possible to prepare this aqueous dispersion. Applications: all fields in which it is desirable to coat a substrate with a thermoplastic film and, in particular, the sizing of reinforcing fibres intended to be incorporated into the composition of parts made of thermoplastic matrix composite materials and, in particular, of structural parts for the aeronautical and space industries.

### TECHNICAL FIELD

The invention relates to the field of the coating of substrates by thermoplastic polymer films.

More specifically, the invention relates to an aqueous dispersion of particles of at least one thermoplastic polymer which has, among other advantages, those of having rheological properties such that it is viscous at rest but fluid under shear—which has, notably, the consequence that it is stable for several hours in the absence of stirring and easily re-dispersible after destabilisation—and which leads, after deposition on a substrate and evaporation of the water contained therein, to the formation of a homogeneous thermoplastic film on said substrate.

Furthermore, this aqueous dispersion may be prepared by a method that is simple to implement and which does not necessitate using high molecular weight additives, that is to say, in practice, of molecular weight greater than 1000 g/mol.

The invention thus also relates to this preparation method.

The invention may find applications in all fields where it is wished to coat a substrate with a thermoplastic film, for example to protect said substrate against corrosion, abrasion or other, to modify its surface properties (wettability, resistance, adsorption, adhesion, compatibility with regard to another material, etc.), to improve the aspect thereof or to give it a particular finish, or even to decorate it.

However, it finds a quite particular interest in the field of sizing of reinforcing fibres intended to be incorporated into the composition of parts made of thermoplastic matrix composite materials and, notably, structural parts for the aeronautical and space industries.

The invention also relates to the use of said aqueous dispersion to coat at least one substrate with a thermoplastic film and, in particular, to size reinforcing fibres for thermoplastic matrix composite materials.

### PRIOR ART

Composite materials are heterogeneous materials that make it possible to exploit the exceptional mechanical properties of materials that it is not known how to manufacture in bulk form but only in fibre form by embedding them in a polymer matrix which makes it possible to link the fibres together, to ensure the spreading of stresses in the composite materials and to protect the fibres against chemical aggressions.

An indispensable condition for obtaining a high performance composite material is that the bond between the reinforcing fibres and the polymer matrix that constitutes it is good. Indeed, if the reinforcing fibres/matrix bond is insufficient, then a composite material with mediocre transversal mechanical properties (such as the shear strength) is obtained and, thus, with very limited possibilities of use, parts made of composite materials being in fact usually intended to work in three-dimensional stress state.

The fibres that are conventionally used as reinforcing material, such as carbon fibres, naturally have a low adhesion with regard to polymer matrices.

Also, the manufacturers of reinforcing fibres have sought to adapt their fibres to the polymers liable to be used as matrices by the manufacturers of composite material parts.

This adaptation has been done in two different and complementary manners:
on the one hand, by surface treatments which all aim to create, on the surface of the fibres, functional groups able to react with the chemical functions borne by the polymer(s) of the matrix; these are mainly chemical oxidation or electrolytic treatments but other types of treatment have also been proposed such as thermal plasma treatments, electrolytic treatments in acidic or basic medium and Si or B type atom implantation treatments; and
on the other hand, by the use of specific sizings, that is to say by depositing on the surface of the fibres a film of a material, the role of which is to increase compatibility between the fibres and the polymer(s) of the matrix, to facilitate the impregnation of the fibres by these polymer(s) and to ensure “coupling” between the fibres and said polymer(s).

It is to be noted that sizings are also applied on reinforcing fibres with other aims than that of improving their bonding with a polymer matrix such as, for example, that of facilitating their handling, lubricating them and protecting them from the abrasion that they can undergo while being rubbed against each other.

In order to be able to improve the compatibility between reinforcing fibres and a polymer matrix, a sizing must, itself, be compatible with this matrix, that is to say be of the same chemical nature as said matrix.

Given that at present thermosetting resins of the epoxy or epoxy vinyl ester resin type are essentially used to produce matrices of composite materials, the sizings proposed to date are for the most part based on an epoxy polymer.

On the other hand, very few sizings intended for matrices constituted of one or more thermoplastic polymers exist.

Yet, the use of thermoplastic polymers, and in particular so-called “thermostable” thermoplastic polymers (on account of the fact that they conserve their mechanical properties at a temperature of continual use above 150° C.), for the production of matrices potentially presents a great interest, notably for the aeronautical and space industries, because, on the one hand, they make it possible to envisage an improvement in the chemical resistance, the impact resistance and the ageing behaviour of the composite materials, and, on the other hand, because thermosetting matrix composite materials are not recyclable.

It is thus desirable to have available sizings which are suited to the use of thermoplastic matrices and which are thus, themselves, based on one or more thermoplastic polymers.

The sizing of reinforcing fibres is generally carried out by immersion of said fibres by running them through a bath containing a sizing formulation, then drying the fibres as they come out of said bath.

For reasons of safety, public health but also environmental protection (compliance with Regulation (CE) n° 1907/2006 of the European Parliament and Counsel known as “REACH”), it is increasingly sought that sizing baths are aqueous and not organic.

Yet, it turns out that thermoplastic polymers and, notably, thermostable thermoplastic polymers are typically insoluble in water.

Sizing baths based on such thermoplastic polymers thus can only, a priori, be in the form of aqueous dispersions in which these polymers are present in the form of particles.

In order to be able to be used as sizing baths at an industrial scale and to lead to sizing of good quality, it is desirable that these aqueous dispersions satisfy a certain number of requirements.

Notably, it would be desirable that they have a stability in the absence of stirring compatible with their use (several hours suffice) while being easily re-dispersible after destabilisation.

It would also be desirable that these aqueous dispersions are sufficiently fluid to spread out easily on the surface of the fibres when the latter are immersed in the sizing bath but that, in spite of this fluidity, the fibres do not drip once they have been removed the sizing bath.

It would further be desirable that the particles of the polymer(s) present in these aqueous dispersions, apart from being in sufficient quantity (generally, it is desirable that the polymer(s) are present at a level of 0.1% to 1% by weight with respect to the weight of fibres), have a size as small as possible and, whatever the case, less than 1 μm so that these particles can penetrate and seep between the elementary filaments of which the reinforcing fibres are formed and thereby form by coalescence a homogenous thermoplastic film on the surface of the fibres or elementary filaments after evaporation of the water.

It would moreover be desirable that these aqueous dispersions have these properties while comprising the least possible additives and, especially, while being exempt of high molecular weight additives such as viscosifiers (alginates, pectins, carboxymethylcellulose, etc.) which are conventionally used to stabilise aqueous dispersions of particles. Indeed, it is desirable that on coming out of the sizing bath, there does not remain on the surface of the fibres any compound liable to degrade during the later implementation of the sized fibres to make composite material parts and, thereby, to perturb this implementation, which is possible if the sizing bath only comprises low molecular weight additives, which can be easily eliminated by calcination during the phase of drying the fibres which follows their passage in the sizing bath.

Finally, it would be desirable that they can be obtained by a method that is compatible, both as regards its implementation and its cost, with exploitation at an industrial scale.

Among works that have concerned the development of aqueous dispersions of particles of a thermoplastic polymer for the sizing of reinforcing fibres may be cited the works of Broyles et al. relative to a sizing based on a powder of a phenoxy polyhydroxyether simply dispersed in water (Polymer 1998, 39(15), 3417-3424, hereafter reference [1]), as well as the works of Giraud et al. relative to sizings based on particles of a polyetherimide or a polyetherketoneketone, stabilised by sodium dodecylsulphate, sodium dioctylsulphosuccinate or benzalkonium chloride (FR-A-2 960 878; Applied Surface Science 2013, 266, 94-99, hereafter references [2] and [3]).

However, it turns out that the aqueous dispersions of particles proposed by these authors do not meet the aforementioned requirements.

On the other hand, within the scope of their works, the Inventors have observed that the presence of giant micelles in aqueous dispersions of particles of one or more thermoplastic polymers makes it possible to confer rheological properties on these dispersions such that they are viscous at rest but fluid under shear, which allows them:
on the one hand, to have a certain stability in the absence of stirring while being re-dispersible, after destabilisation, by simple manual or mechanical stirring, and
on the other hand, to spread easily on the surface of a substrate (such as the surface of reinforcing fibres) under the effect of shear (such as the stirring to which a sizing bath is subjected) while being capable of becoming viscous again after stopping this shear.

They have also observed that these aqueous dispersions may be obtained by a method of emulsion/evaporation of solvent or dispersion/evaporation of solvent, enabling said aqueous dispersions to comprise very small particles of thermoplastic polymer(s).

And it is on these observations that the present invention is based.

### DESCRIPTION OF THE INVENTION

The invention thus firstly relates to the use of giant micelles as shear-thinning agent and, notably, as stabilising agent in an aqueous dispersion of particles of at least one thermoplastic polymer.

The invention also relates to an aqueous dispersion of particles of at least one thermoplastic polymer, which is characterised in that it comprises giant micelles which are located around the particles of the thermoplastic polymer(s).

Within the scope of the present invention, the term “giant micelles” should be understood according to the sense that is given to it in the literature, namely that they are objects that are in the form of cylinders which can reach several microns length for a diameter of several nanometres and which result from the aggregation by self-assembly of surfactant molecules in aqueous solution. In solution, these objects behave in an analogous manner to polymers. However, they are liable to break up and to reform in a spontaneous manner under the effect of shear, which is why they are sometimes given the nickname of “living polymers”. These micelles, which are also known as “worm-like micelles” have notably been described by Cates et al. (Journal of Physics: Condensed Matter 1990, 2, 6869-6892, hereafter reference [4]), Hassan et al. (Current Science 2001, 80(8), 980-989, hereafter reference [5]) and by Walker (Current Opinion in Colloid & Interface Science 2001, 6, 451-456, hereafter reference [6]).

In accordance with the invention, the giant micelles comprise, preferably, molecules of a cationic or zwitterionic surfactant.

As cationic surfactant, it is notably possible to use a salt selected from:
alkyltrimethylammonium salts of formula (CₙH₂ₙ₊₁)N⁺(CH₃)₃,X⁻ (wherein n is greater than or equal to 10 and X⁻ is an inorganic or organic counterion) such as decyltrimethylammonium bromide (or C₁₀TAB), dodecyltrimethylammonium bromide (or DTAB), tetradecyltrimethylammonium bromide (or TTAB), hexadecyltrimethylammonium bromide (or CTAB, also called cetyltrimethylammonium bromide), octadecyltrimethylammonium bromide (or OTAB), decyltrimethylammonium chloride (or C₁₀TAC), dodecyltrimethylammonium chloride (or DTAC), tetradecyltrimethylammonium chloride (or TTAC), hexadecyltrimethylammonium chloride (or CTAC, also called cetyltrimethylammonium chloride), octadecyltrimethylammonium chloride (or OTAC), hexadecyltrimethylammonium p-tosylate (or CTAT, also called cetyltrimethylammonium p-tosylate), tetradecyltrimethylammonium salicylate (or C₁₄TASal), hexadecyltrimethylammonium salicylate (or C₁₆TASal, also called cetyltrimethylammonium salicylate) or cetyltrimethylammonium 3-hydroxynaphthalene-2-carboxylate (or CTAHNC);
alkyldimethylethylammonium salts of formula (CₙH₂ₙ₊₁)N⁺(CH₃)₂(C₂H₅),X⁻ (wherein n is greater than or equal to 10 and X⁻ is an inorganic or organic counterion) such as hexadecyldimethylethylammonium bromide (or CDMEAB, also called cetyldimethylethylammonium bromide) or hexadecyldimethylethylammonium chloride (or CDMEAC, also called cetyldimethylethylammonium chloride);
alkylpyridinium salts of formula (CₙH₂ₙ₊₁)C₅H₅NH⁺,X⁻ (wherein n is greater than or equal to 10 and X⁻ is an inorganic or organic counterion) such as hexadecylpyridinium bromide (or DPB, also called decylpyridinium bromide), hexadecylpyridinium chloride (or CPC, also called cetylpyridinium chloride) or hexadecylpyridinium chlorate (or CPClO₃, also called cetylpyridinium chlorate); and
benzyldimethylammonium salts such as benzyldimethyl(hydrogenated tallow)ammonium chloride (or DMHTC).

As for the zwitterionic surfactant, it may notably be selected from fatty chain betaines, typically C₁₀ to C₂₆, such as erucyl dimethyl amidopropyl betaine.

According to a preferred embodiment of the invention, the surfactant is a cationic surfactant with a quaternary ammonium group, more particularly an alkyltrimethylammonium salt as defined previously and, better still, a hexadecyltrimethylammonium salt such as CTAB, CTAC, CTAT or C₁₆TASal, preference being given among all to CTAC.

As known per se, the formation of giant micelles by surfactants requires, with few exceptions, that a salt is added to these surfactants, which may be inorganic (sodium chloride, sodium bromide, potassium bromide for example) or organic (sodium salicylate, sodium phthalate for example), or that an organic acid is added such as salicylic acid, phthalic acid, chlorobenzoic acid or a hydroxynaphthoic acid such as 5-hydroxy-1-naphthoic acid, 6-hydroxy-1-naphthoic acid, 7-hydroxy-1-naphthoic acid, 1-hydroxy-2-naphthoic acid or 3-hydroxy-2-naphthoic acid.

Also, the giant micelles further comprise, advantageously, an inorganic or organic salt or an organic acid and, preferably, salicylic acid.

In accordance with the invention, the thermoplastic polymer(s) may be selected from all thermoplastic polymers capable of being used to coat a substrate with a thermoplastic film. Thus, these thermoplastic polymer(s) may notably be selected from polyaryletherketones (or PAEK) such as polyetherketones (or PEK), polyetheretherketones (or PEEK) or polyetherketoneketones (or PEKK), polyethyleneimines (or PEthl), polyetherimides (or PEI), polyimides (or PI), polyolefins such as polyethylenes, notably high density, polypropylenes or copolymers of ethylene and polypropylene, polyamides such as polyamides 6 (or PA-6), 1.1 (or PA-1.1), 12 (or PA-12), 6.6 (or PA-6.6), 4.6 (or PA-4.6), 6.10 (or PA-6.10), 6.12 (or PA-6.12) or aromatic polyamides, in particular polyphthalamides or aramids, thermoplastic polyurethanes (or TPU), poly(phenylene sulphides) (or PPS), poly(ethylene terephthalates) (or PET), poly(butylene terephthalates) (or PBT), polysulphones such as actual polysulphones (or PSU), polyethersulphones (or PES) or polyphenylsulphones (or PPSU), polycarbonates, poly(vinyl chlorides), poly(vinyl alcohols) and mixtures of these polymers.

For the sizing of reinforcing fibres with a view to the manufacture of composite materials parts and, notably, structural parts for the aeronautical and space industries, the thermoplastic polymer(s) are, preferably, selected from thermostable thermoplastic polymers, that is to say in practice from polyaryletherketones, polyetherimides and polysulphones.

In which case, the giant micelles are, preferably, formed of a mixture of molecules of CTAC and salicylic acid, the Inventors having, in fact, demonstrated by thermogravimetric analyses that CTAC is degraded 75% by weight at 150° C. whereas salicylic acid is totally degraded at 180° C., i.e. temperatures that are below the degradation temperature that these thermoplastic polymers typically have. It is thus possible to carry out the drying of the reinforcing fibres when they come out of the sizing bath at a temperature making it possible to remove ¾ by weight of the CTAC and the totality of the salicylic acid without affecting the structure of the thermoplastic polymer(s). Moreover, the 25% by weight of CTAC which are not degraded correspond to a tertiary amine residue which is not liable to perturb the quality of the sizing of the reinforcing fibres or their later implementation for the manufacture of composite materials parts.

This mixture of CTAC and salicylic acid, which is preferentially an equimolar mixture, is advantageously present in the aqueous dispersion at a concentration ranging from 5 mmol/L to 100 mmol/L and, preferably, from 40 mmol/L to 50 mmol/L.

In all cases, the weight content of the aqueous dispersion in particles of the thermoplastic polymer(s), with respect to the total weight of said dispersion, ranges from 0.1% to 3%, preferably between 0.1% and 1% and, better still, 0.4% to 0.6%.

As mentioned previously, the aqueous dispersion may be obtained by a method of emulsion/evaporation of solvent or dispersion/evaporation of solvent.

The invention also relates to a method for preparing an aqueous dispersion of particles of at least one thermoplastic polymer as defined previously, which is characterised in that it comprises:

a) bringing into contact, under stirring, an organic phase comprising the thermoplastic polymer(s) dissolved or dispersed in an organic solvent, non-miscible with water, with an aqueous phase comprising giant micelles; and

b) evaporating the organic solvent;

whereby the thermoplastic polymer(s) are transferred in the form of particles from the organic phase to the aqueous phase.

Preferably, steps a) and b) are carried out simultaneously, the organic solvent advantageously being a volatile solvent at room temperature (chloroform, dichloromethane, dichloroethane, ethyl acetate, ethyl formate, cyclohexane, diethyl ether or a mixture thereof for example) so as to be able to be evaporated uniquely under the effect of the stirring to which the organic and aqueous phases are subjected when they are brought into contact.

In practice, this method is advantageously implemented by adding, drop by drop, the organic phase comprising the thermoplastic polymer(s) dissolved or dispersed in the organic solvent to an aqueous solution comprising the elements necessary for the formation of giant micelles (namely a surfactant which, is, preferably, a cationic or zwitterionic surfactant and potentially an inorganic or organic salt or an organic acid), and doing so under vigorous stirring (typically greater than 10,000 rpm if a stirring device of the Ultra-Turrax™ type is used), and while maintaining this stirring up to complete evaporation of the organic solvent.

The invention further relates to the use of an aqueous dispersion of particles of at least one thermoplastic polymer as defined previously to coat at least one substrate with a thermoplastic film and, in particular, to size reinforcing fibres for thermoplastic matrix composite materials.

In accordance with the invention, the reinforcing fibres may be selected from all fibres capable of being used as reinforcement in the manufacture of composite material parts. Thus, they may notably be glass fibres, quartz fibres, carbon fibres, graphite fibres, silica fibres, metal fibres such as steel fibres, aluminium fibres or boron fibres, ceramic fibres such as fibres of silicon carbide or boron carbide, synthetic organic fibres such as aramid fibres, polyethylene fibres, polyester fibres or poly(p-phenylene benzobisoxazole) fibres, better known under the acronym PBO, natural organic fibres such as hemp fibres, linen fibres or silk fibres, or instead mixtures of such fibres.

The reinforcing fibres are, preferably, in the form of yarns grouping together several thousand elementary filaments (typically 3,000 to 48,000) measuring, for example, 6 to 10 μm diameter in the case of carbon fibres. Fibres of this type are known as “rovings” or “tapes”.

Moreover, the sizing of reinforcing fibres comprises, preferably, the immersion of these reinforcing fibres in the aqueous dispersion then their drying. In an alternative, however, it may also be carried out by spraying the aqueous dispersion on the reinforcing fibres then drying these fibres.

Other characteristics and advantages of the invention will become clearer on reading the complement to the description that follows, which relates to examples of preparation of aqueous dispersions in accordance with the invention and the demonstration of the properties thereof, and which is given with reference to the appended figures.

Obviously, this complement to the description is only given as an illustration of the object of the invention and does not constitute in any way a limitation of this object.

### BRIEF DESCRIPTION OF THE FIGURES

FIG. 1 illustrates the evolution of the stability of a first aqueous dispersion in accordance with the invention, as determined by multiple light scattering over a period of 50 hours, this first aqueous dispersion being a dispersion of particles of a polyetherimide.

FIG. 2 illustrates the rheograms of said first aqueous dispersion as established twice, on the one hand, on the day of its preparation (symbols ▴ and Δ) and, on the other hand, after 7 days of rest and re-dispersion by simple manual stirring (symbols ● and ◯).

FIG. 3 is a transmission electron microscope (TEM) image of said first aqueous dispersion.

FIG. 4 is a scanning electron microscope (SEM) image of a film obtained by deposition of said first aqueous dispersion on a graphite plate and drying of said plate.

FIG. 5 is a diagram illustrating the sizing device having been used to size carbon fibres with said first aqueous dispersion.

FIGS. 6A and 6B are SEM images of filaments of a carbon fibre having been sized with said first aqueous dispersion by means of the device shown in FIG. 5 and using a running speed of 10 m/minute.

FIGS. 7A and 7B are SEM images of filaments of a carbon fibre having been sized with said first aqueous dispersion by means of the device shown in FIG. 5 and using a running speed of 15 m/minute.

FIGS. 8A and 8B are SEM images of filaments of a carbon fibre not having been sized, these images being given for comparison purposes.

FIG. 9 is an SEM image of a film formed by deposition of a second aqueous dispersion in accordance with the invention on a graphite plate and drying of said plate, said second aqueous dispersion being a dispersion of particles of a polyethersulphone.

FIG. 10 is an SEM image of a film formed by deposition of a third aqueous dispersion in accordance with the invention on a graphite plate and drying of said plate, said third aqueous dispersion being a dispersion of particles of a polysulphone.

### DETAILED DESCRIPTION OF PARTICULAR EMBODIMENTS

### Example I

### Aqueous Dispersion of Particles of a Polyetherimide

I.1 Preparation of the dispersion:

An aqueous dispersion of particles of a polyetherimide (Ultem™ 1000 PEI resin—GE Plastics), hereafter designated dispersion 1, is prepared by emulsion/evaporation. This PEI has a glass transition temperature of 217° C.

To do so, 0.71 g of the PEI resin is dissolved in 13.6 mL of dichloromethane under magnetic stirring.

In parallel, also under magnetic stirring, 1.868 g of cetyltrimethylammonium chloride (CTAC) are dissolved in 136.4 mL of distilled water (i.e. a concentration of CTAC of 4.11.10⁻² mol/L) then, to the solution thereby obtained, is added 0.805 g salicylic acid (i.e. a concentration of salicylic acid also of 4.11.10⁻² mol/L).

The organic resin solution is added drop by drop to the aqueous solution of CTAC/salicylic acid under stirring with the Ultra-Turrax™—IKA. The addition lasts around 5 minutes. The stirring is set at 12,000 rpm and is maintained up to complete evaporation of the dichloromethane, i.e. around 30 minutes.

An aqueous dispersion with 0.51% by weight of particles of PEI is thereby obtained.

I.2—Properties of the dispersion:
Particle size:

The mean diameter and the polydispersity index of the particles of dispersion 1 are determined by means of a Zetasizer Nano S dynamic light scattering apparatus—MALVERN Instruments, using a high power laser (50 mW) emitting at the wavelength of 532 nm and collecting the light signal scattered by the sample to analyse in backscattering (angle of) 173°. The measurement is carried out at 25° C.

The mean intensity diameter of the particles is 209 nm.

Their polydispersity index is 0.265.
Stability of the dispersion:

The stability of dispersion 1 is assessed by means of a Turbiscan™ LAB-FORMULACTION device which makes it possible to characterise precisely and rapidly the stability of a liquid dispersion by multiple light scattering (MLS).

Multiple light scattering is a well-known method which consists in sending photons (λₑₘᵢₛₛᵢₒₙ=880 nm) into the sample to analyse. These photons, after having been scattered multiple times by the particles of the dispersion, come out of the sample and are detected by two detectors, one working in transmission, the other in backscattering (angle of) 135°. The analysis is carried out at 25° C.

The backscattering intensity is directly linked to the transport length of the photons. Also, this intensity depends on the size and the concentration of the particles.

Monitoring of the difference between the intensity of the backscattered light at time t0 and at time t (Rₜ₀−Rₜ) is carried out for several days with an interval of 3 hours between each measurement.

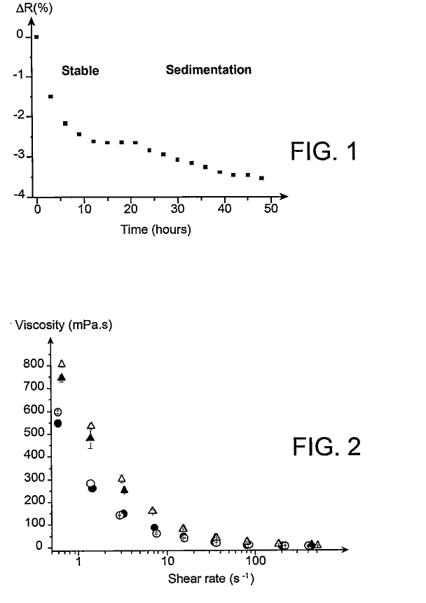

FIG. 1 illustrates, in the form of a curve, the evolution of the variation in the backscattering intensity with respect to the backscattering intensity at time t0 (i.e. (Rₜ₀−Rₜ)/Rₜ₀), noted AR and expressed in percentages, such as obtained for dispersion 1 over a period of 50 hours.

As shown in this figure, the curve shows a modification of slope, characteristic of a start of sedimentation of the particles as of 22 hours. Dispersion 1 thus begins to be destabilised only after 22 hours.
Rheological analysis of the dispersion:

The rheology of dispersion 1 is assessed by tests which consist in measuring the viscosity of said dispersion by applying to it a shear rate ranging from 0.6 s⁻¹ to 500 s⁻¹, and doing so, on the one hand, on the day of its preparation and, on the other hand, after 7 days at rest and re-dispersion by simple manual stirring. Each test is performed twice.

FIG. 2 illustrates the rheograms thereby obtained, the viscosity being expressed in mPa·s and the shear rate in s⁻¹. In this figure, the symbols ▴ and Δ correspond to the rheograms obtained on the day dispersion 1 is prepared whereas the symbols ● and ◯ correspond to the rheograms obtained after 7 days of rest of said dispersion.

As shown in FIG. 2, dispersion 1 has, on the day of its preparation, a viscosity of the order of 800 mPa·s without shear and its viscosity drops to 500 mPa·s from the moment that a shear rate of 1 s⁻¹ is applied.

It also shows that simple manual stirring suffices for dispersion 1 to recover, after 7 days at rest, a viscosity close to that which it had on the day of its preparation.
Microscopic analysis:

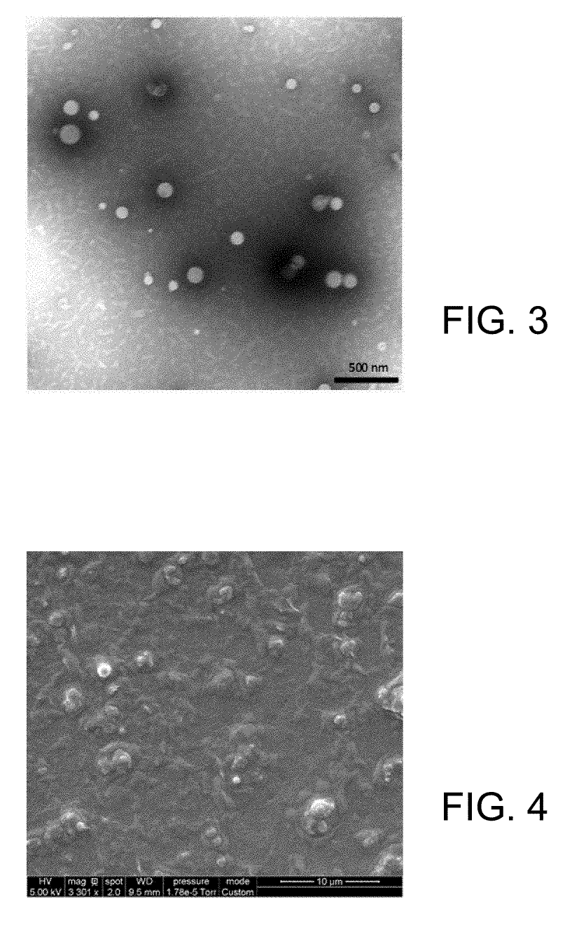

As shown in FIG. 3, which corresponds to a TEM image of dispersion 1, said dispersion comprises spherical particles (shown on the image in the form of white circles) which have a maximum diameter of 200 nm, encased in the middle of cylindrical micelles.

The size distribution of these particles is polydisperse (the size of the particles ranging from 20 nm to 200 nm) in agreement with the results obtained by dynamic light scattering.
Film-forming properties:

The aptitude of dispersion 1 to form a film on a substrate is firstly tested by depositing a drop of said dispersion on a graphite plate using a Pasteur pipette, by spreading this drop then by placing the plate in a drying oven at 100° C. to dry said deposit.

As is visible in FIG. 4, which corresponds to an SEM image of the graphite plate after drying of the deposit, the film obtained is homogenous and shows a good coalescence of PEI particles.

Moreover, the aptitude of dispersion 1 to form a film on a substrate is also tested by sizing multifilament carbon fibres (IM7 fibres with 12,000 filaments—HEXCEL) with this dispersion.

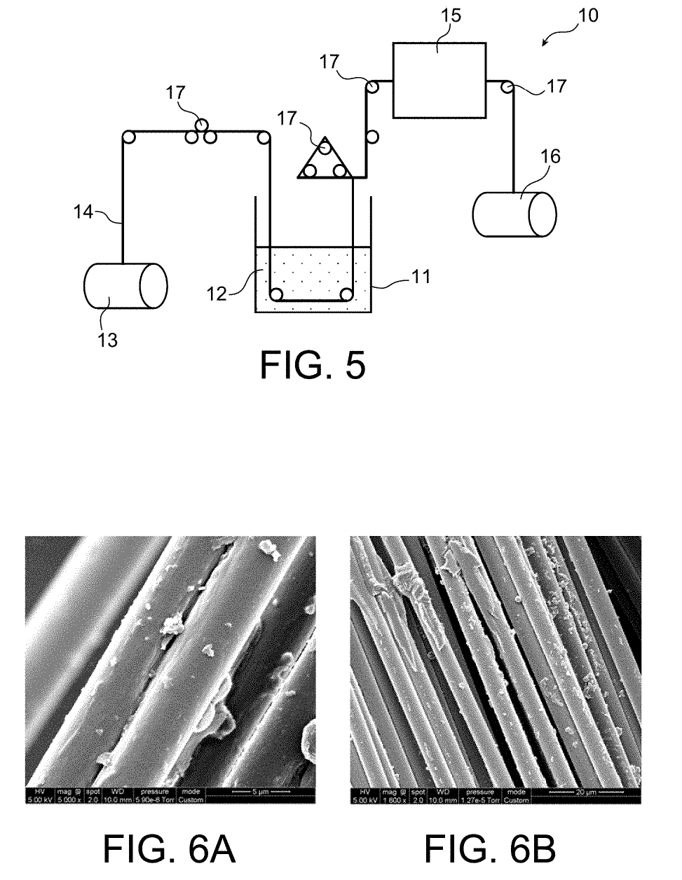

This sizing is carried out using the device 10 which is illustrated schematically in FIG. 5 and which comprises:

a tank 11 which is filled with a sizing bath 12 (here, dispersion 1);
a spool 13 which is located upstream (in the direction of unwinding of the carbon fibres in the device 10) of the tank 11 and on which the carbon fibres 14 are wound before their introduction into the sizing bath;
a drying oven 15 which is located downstream of the tank 11 and which makes it possible to dry the carbon fibres when they come out of the sizing bath;
a spool 16 which is located downstream of the drying oven 15 and on which the carbon fibres are wound when they come out of this drying oven; and
a drive system comprising notably a set of pulleys 17 and ensuring the unwinding of the rovings of reinforcing fibres from the spool 13 to the spool 16.

The temperature of the drying oven is set at 200° C. such that it is below the glass transition temperature of the PEI.

Two running speeds of carbon fibres in the device 10 are used: 10 m/min on the one hand, and 15 m/min on the other hand.

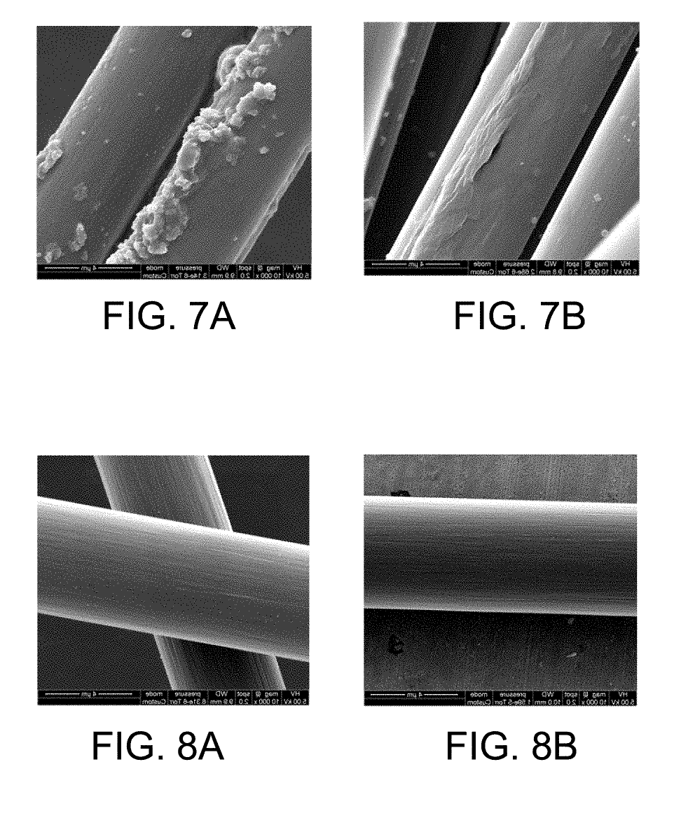

The results are illustrated in FIGS. 6A, 6B, 7A, 7B, 8A and 8B which correspond to SEM images:
filaments of a carbon fibre having been sized at the running speed of 10 m/min (FIGS. 6A and 6B);
filaments of a carbon fibre having been sized at the running speed of 15 m/min (FIGS. 7A and 7B); and by way of comparison
filaments of a carbon fibre not having been sized (FIGS. 8A and 8B).

These images show that sizing of multi-filament carbon fibres with dispersion 1 leads to the formation of a homogeneous film on the filaments of said fibres, with very good coalescence of the particles of PEI present in said dispersion.

### EXAMPLE II

### Aqueous Dispersion of Particles of a Polyethersulphone

II.1—Preparation of the dispersion:

An aqueous dispersion of particles of a polyethersulphone (PES 4100 P—SUMIMOTO Chemical), hereafter designated dispersion 2, is prepared by operating as described in point I.1 above, except that PEI is replaced by PES, which forms a stable dispersion in the organic solvent. This PES has a glass transition temperature of 225° C.

I1.2—Properties of the dispersion:

Dispersion 2 has:
particles of which the mean intensity diameter and the polydispersity index, as determined by dynamic light scattering, are respectively 158 nm and 0.210;
a stability, as assessed by visual observation, of 10 to 12 hours.

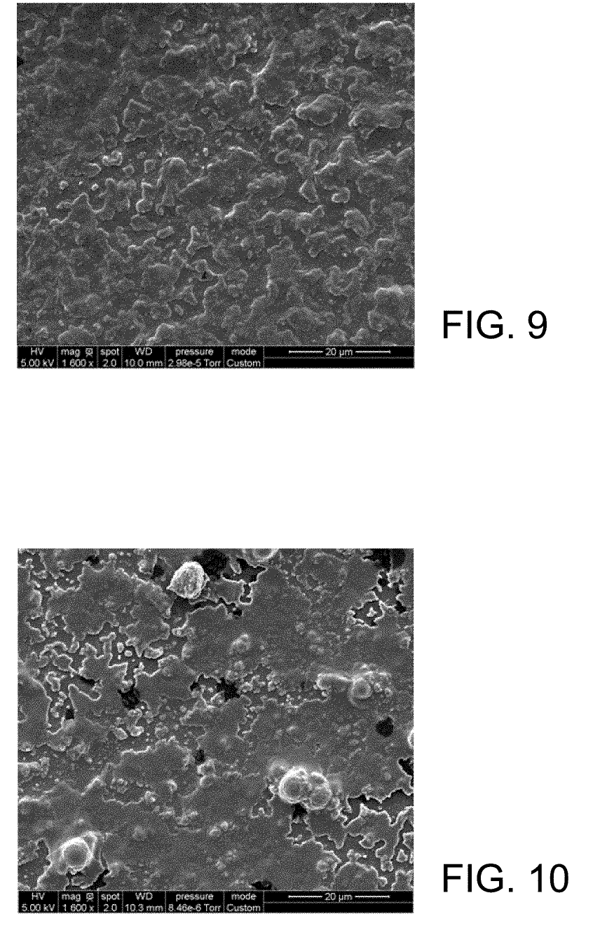

Moreover, as shown in FIG. 9, which corresponds to an SEM image of a graphite plate treated with a drop of dispersion 2 as described in point I.2 above, said dispersion makes it possible to form a homogenous film of PES on the surface of a substrate.

### Example III

### Aqueous Dispersion of Particles of a Polysulphone

III.1—Preparation of the dispersion:

An aqueous dispersion of particles of a polysulphone (PSU Ultrason™ S 2010 Naturel—BASF), hereafter designated dispersion 3, is prepared by operating as described in point I.1 above, except that PEI is replaced by PSU. This PSU has a glass transition temperature of 187° C.

III.2—Properties of the dispersion:

Dispersion 3 has:
particles of which the mean intensity diameter and the polydispersity index, as determined by dynamic light scattering, are respectively 178 nm and 0.297;
a stability, as assessed by visual observation, of 10 to 12 hours.

Moreover, as shown in FIG. 10, which corresponds to an SEM image of a graphite plate having been treated with a drop of dispersion 3 as described in point I.2 above, said dispersion also makes it possible to form a homogeneous film of PSU on the surface of a substrate.

### REFERENCES CITED

[1] Broyles et al., Polymer 1998, 39(15), 3417-3424

[2] FR-A-2 960 878;

[3] Giraud et al., Applied Surface Science 2013, 266, 94-99

[4] Cates et al., Journal of Physics: Condensed Matter 1990, 2, 6869-6892

[5] Hassan et al., Current Science 2001, 80(8), 980-989

[6] Walker, Current Opinion in Colloid & Interface Science 2001, 6, 451-456

What is claimed is:

1-18. (canceled)

19. An aqueous dispersion of particles of at least one thermoplastic polymer, comprising giant micelles located around the particles of the thermoplastic polymer.

20. The aqueous dispersion of claim 19, wherein the giant micelles comprise molecules of a cationic or zwitterionic surfactant.

21. The aqueous dispersion of claim 19, wherein the giant micelles comprise molecules of a cationic surfactant with a quaternary ammonium group.

22. The aqueous dispersion of claim 21, wherein the cationic surfactant is an alkyltrimethylammonium salt of formula (CₙH₂ₙ₊₁)N⁺(CH₃)₃,X⁻, wherein n is greater than or equal to 10 and X⁻ is an inorganic or organic counterion.

23. The aqueous dispersion of claim 22, wherein the alkyltrimethylammonium salt is a hexadecyltrimethylammonium salt.

24. The aqueous dispersion of claim 20, wherein the giant micelles further comprise an inorganic salt, an organic salt or an organic acid.

25. The aqueous dispersion of claim 20, wherein the giant micelles further comprise salicylic acid.

26. The aqueous dispersion of claim 19, wherein the thermoplastic polymer is a polyaryletherketone, a polyethyleneimine, a polyolefin, a polyamide, a polyimide, a thermoplastic polyurethane, a polyphenylene sulphide, a polyethylene or polybutylene terephthalate, a polysulphone, a polycarbonate, or a polyvinyl chloride.

27. The aqueous dispersion of claim 26, wherein the thermoplastic polymer is a polyaryletherketone, a polyetherimide, or a polysulphone.

28. The aqueous dispersion of claim 27, wherein the giant micelles are formed of a mixture of molecules of hexadecyltrimethylammonium chloride and salicylic acid.

29. The aqueous dispersion of claim 28, comprising from 5 mmol/L to 100 mmol/L of the mixture.

30. The aqueous dispersion of claim 19, comprising from 0.1% to 1% by weight of thermoplastic polymer particles with respect to a total weight of the aqueous dispersion.

31. A method for preparing an aqueous dispersion of particles of at least one thermoplastic polymer, the aqueous dispersion comprising giant micelles which are located around the particles of the thermoplastic polymer, comprising:
a) bringing into contact, under stirring, an organic phase comprising the thermoplastic polymer dissolved or dispersed in an organic solvent, non-miscible with water, with an aqueous phase comprising giant micelles; and
b) evaporating the organic solvent;
whereby the thermoplastic polymer is transferred in the form of particles from the organic phase to the aqueous phase.

32. The method of claim 31, wherein a) and b) are carried out simultaneously.

33. A method for sizing reinforcing fibres for thermoplastic matrix composite materials, comprising:
immersing the reinforcing fibres in an aqueous dispersion of at least one thermoplastic polymer, the aqueous dispersion comprising giant micelles which are located around the particles of the thermoplastic polymer; then
removing the reinforcing fibres from the aqueous dispersion and drying the reinforcing fibres.

34. The method of claim 33, wherein the reinforcing fibres are glass fibres, carbon fibres, graphite fibres, silica fibres, metal fibres, ceramic fibres, synthetic organic fibres, natural organic fibres or mixtures thereof.

35. A method for sizing reinforcing fibres for thermoplastic matrix composite materials, comprising:
spraying an aqueous dispersion of at least one thermoplastic polymer on the reinforcing fibres, the aqueous dispersion comprising giant micelles which are located around the particles of the thermoplastic polymer; then
drying the reinforcing fibres.

36. The method of claim 35, wherein the reinforcing fibres are glass fibres, carbon fibres, graphite fibres, silica fibres, metal fibres, ceramic fibres, synthetic organic fibres, natural organic fibres or mixtures thereof.
